(19) United States
(12) Patent Application Publication
(10) Pub. No.: US 2025/0295133 A1
(43) Pub. Date: Sep. 25, 2025

(54) MICRO-PUREE MACHINE WITH HANDLE

(71) Applicant: SharkNinja Operating LLC, Needham, MA (US)

(72) Inventors: Lukas Tubby, Auburn, MA (US); Nathan Lyell, Brighton, MA (US); Zach Kelley, Needham, MA (US); Jonathan James, Providence, RI (US)

(73) Assignee: SharkNinja Operating LLC, Needham, MA (US)

(21) Appl. No.: 18/609,785

(22) Filed: Mar. 19, 2024

(51) Int. Cl. A23G 9/28; A23G 9/08

(52) U.S. Cl. CPC A23G 9/281; A23G 9/08

(57) ABSTRACT

A handle for a micro-puree machine is provided. The handle includes a lever. An arm is coupled to the lever. The arm is configured to allow the lever to rotate about the arm at an angle. An electrical circuit is coupled to the arm. The electrical circuit is configured to produce a resistance based on the angle rotated by the lever.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro-puree machine. Typically, machines of this nature spin and plunge a blade into a pre-frozen ingredient or combination of ingredients. While able to make frozen desserts like ice creams, gelatos, frozen yogurts, sorbets and the like, micro-puree machines can also prepare non-dessert types of foods such as non-dessert purees and mousses.

### SUMMARY

According to one aspect of the subject matter described in this disclosure, a handle for a micro-puree machine is provided. The handle includes a lever and an arm coupled to the lever. The arm is configured to allow the lever to rotate about the arm at an angle. An electrical circuit is coupled to the arm. The electrical circuit is configured to produce a resistance based on the angle rotated by the lever.

In some implementations, the lever may be vertically positioned on the arm. The arm may be coupled to a rotation structure configured to increase resistance when a user pulls the lever. The handle may further include an interface positioned between the arm and the rotation structure, wherein the interface is configured to protect the rotation structure. The plate may be configured to protect the electrical circuit. The electrical circuit may be a variable resistor or encoder. The electrical circuit may be coupled to an electrical coupler configured to send outputs from the electrical circuit to one or more electrical components.

According to another aspect of the subject matter described in this disclosure, a micro-puree machine is provided. The micro-puree machine includes a motor and an extrusion output shaft coupled to the motor. The extrusion output shaft extrudes food materials in a processing bowl of the micro-puree machine based on an output speed of the motor. A handle is coupled to the motor. The handle including: a lever, and an arm coupled to the lever, the arm configured to allow the lever to rotate about the arm at an angle. A first electrical circuit is coupled to the arm. The first electrical circuit is configured to produce a first electrical signal based on the angle rotated by the lever. A second electrical circuit is coupled to the motor. The second electrical circuit is configured to receive the first electrical signal corresponding to the angle rotated by the lever from the first electrical circuit and generate a second electrical signal indicative of the output speed of the motor. The motor receives the second electrical signal from the second electrical circuit and generates the output speed.

In some implementations, the lever may be vertically positioned on the arm. The arm may be coupled to a rotation structure configured to increase resistance when a user pulls the lever. The handle may further include an interface positioned between the arm and the rotation structure, wherein the interface is configured to protect the rotation structure. The interface may be positioned on a plate for support. The first electrical circuit may be a variable resistor or encoder. The first electrical circuit may be coupled to an electrical coupler configured to send outputs from the first electrical circuit to one or more electrical components. The extrusion output shaft may be coupled to a drivetrain. The drivetrain may include a plurality of gears for producing rotational motion. The electric circuit is positioned on a printed circuit board assembly (PCBA).

According to another aspect of the subject matter described in this disclosure, a method of extruding food in a micro-puree machine, including a user-operated lever is provided. The method includes: generating, using a first electrical circuit coupled to the lever, a first electrical signal based on an angle of rotation of the lever by a user; sending the first electrical signal indicative of the angle of rotation of the lever from the first electrical circuit to a second electrical circuit; generating, using the second electrical circuit, a speed signal from the first electrical signal, the speed signal indicative of the output speed of a motor of the micro-puree machine; sending the speed signal to the motor to generate the output speed; and extruding food materials in a processing bowl of the micro-puree machine based on the output speed of the motor.

In some implementations, extruding food materials may include controlling a rate of movement of a plunger along a major axis of a bowl including the food materials based on the speed of the motor.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIGS. 1A-1M are schematic diagrams of a micro-puree machine 100, according to an embodiment of the invention.

FIG. 2 is a detailed schematic diagram of a handle used with the micro-puree machine of FIG. 1, according to an embodiment of the disclosure.

FIG. 3 is a schematic diagram of a variable resistor used with the micro-puree machine of FIG. 1, according to an embodiment of the invention.

FIG. 4 is a schematic diagram of components of the micro-puree machine of FIG. 1, according to an embodiment of the invention.

FIGS. 5A-5B are schematic diagrams of components of the micro-puree machine of FIG. 1 involved in the extrusion process, according to an embodiment of the invention.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example implementations only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

In the specification and claims, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

This document describes a handle that can be used with a micro-puree machine to extrude food. The handle is designed to enable the user to select the speed at which food materials are extruded from the processing bowl of the micro-puree machine. The handle works such that the more the user pulls on it, the faster the food materials are extruded. With this mechanism, users can now effortlessly control how much and how quickly food materials are extruded.

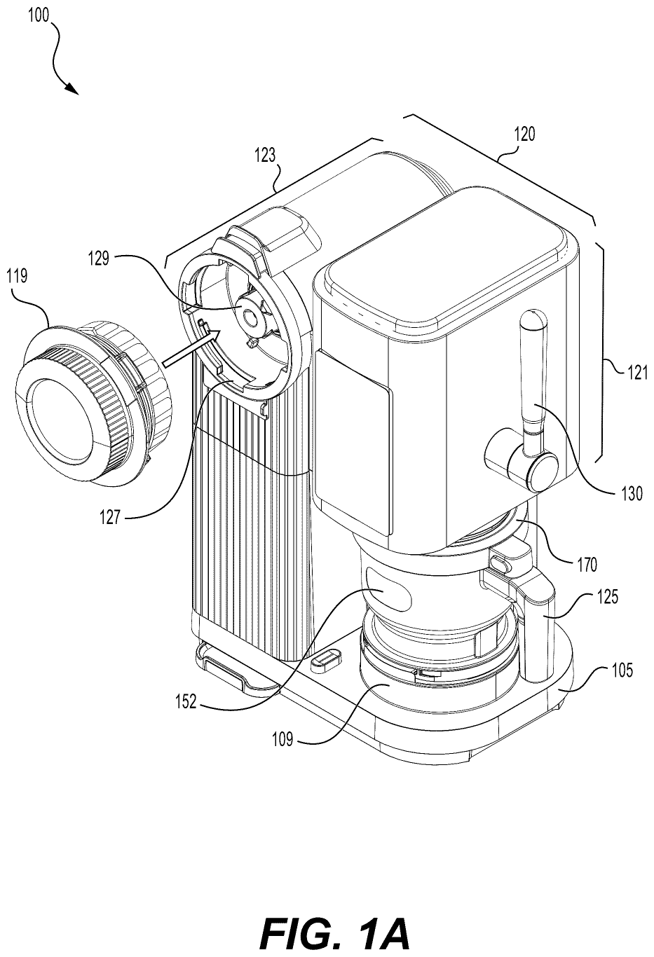

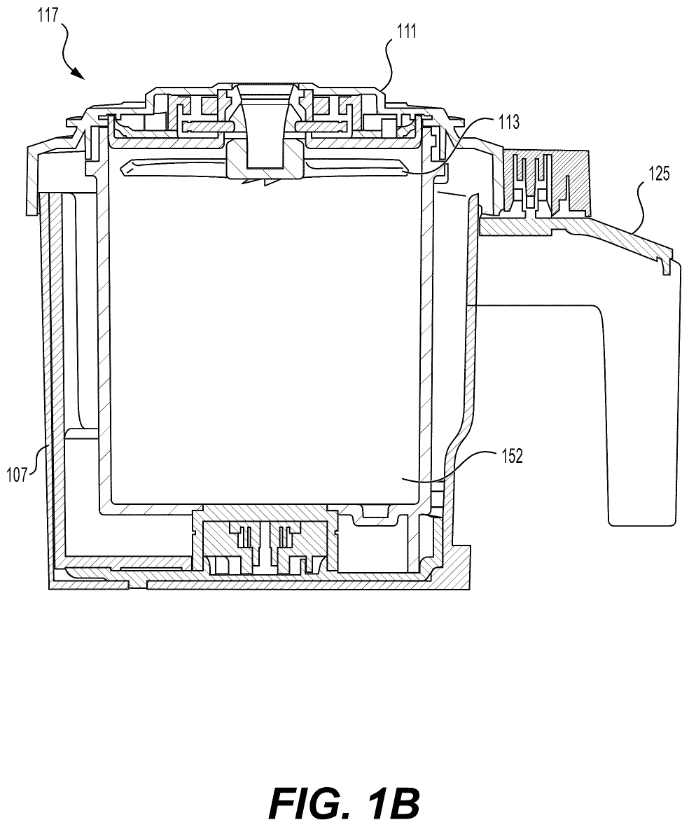

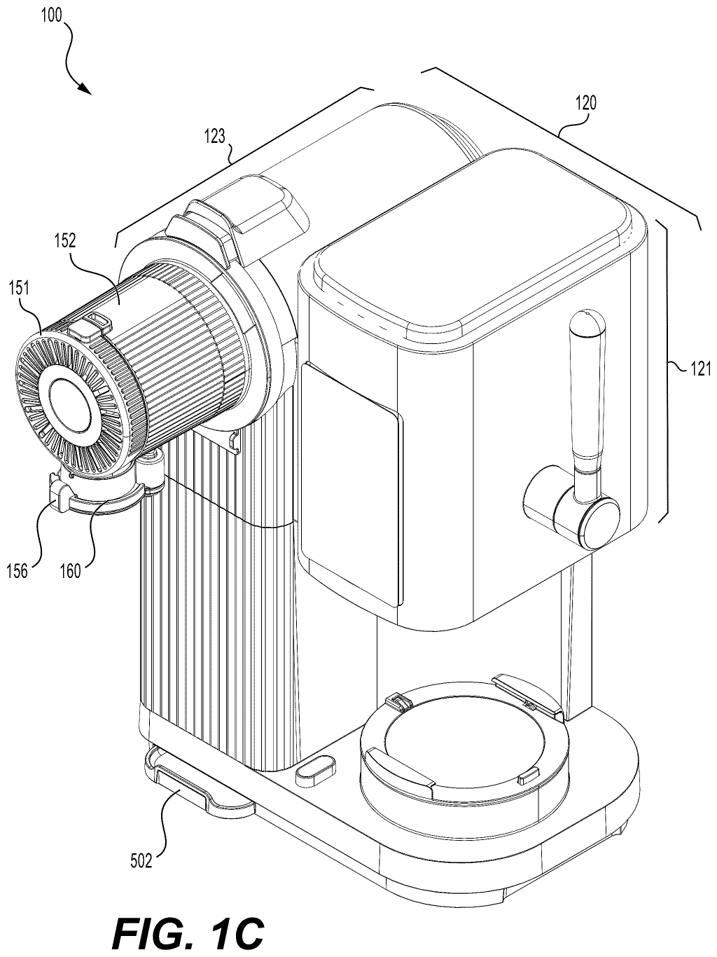

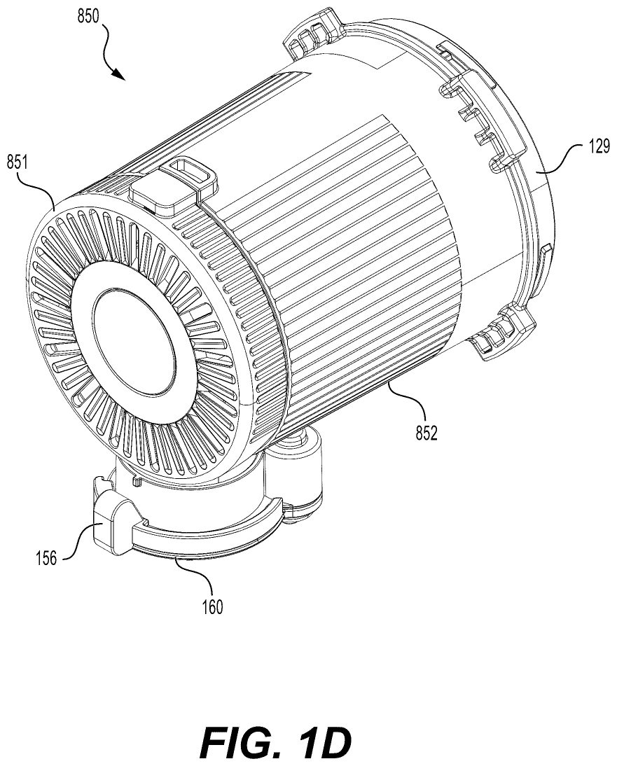

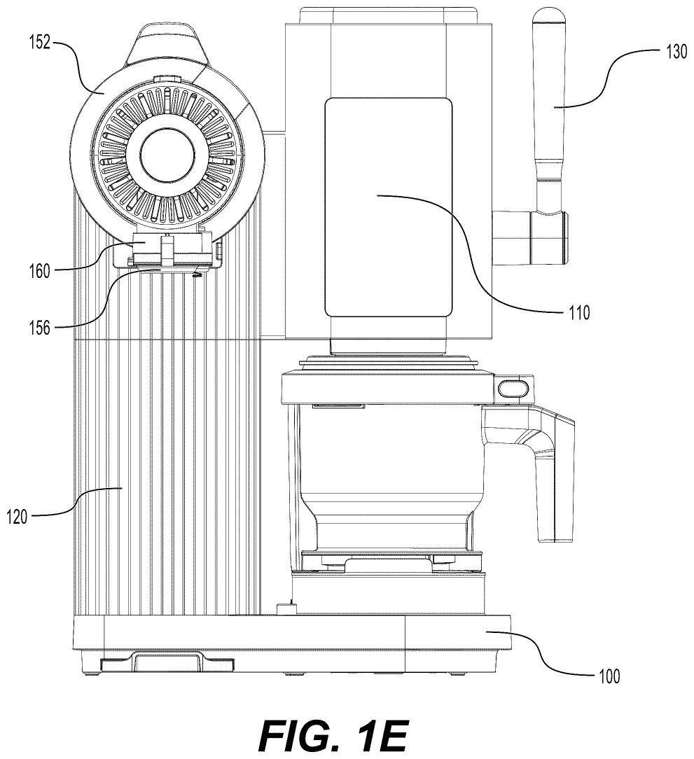

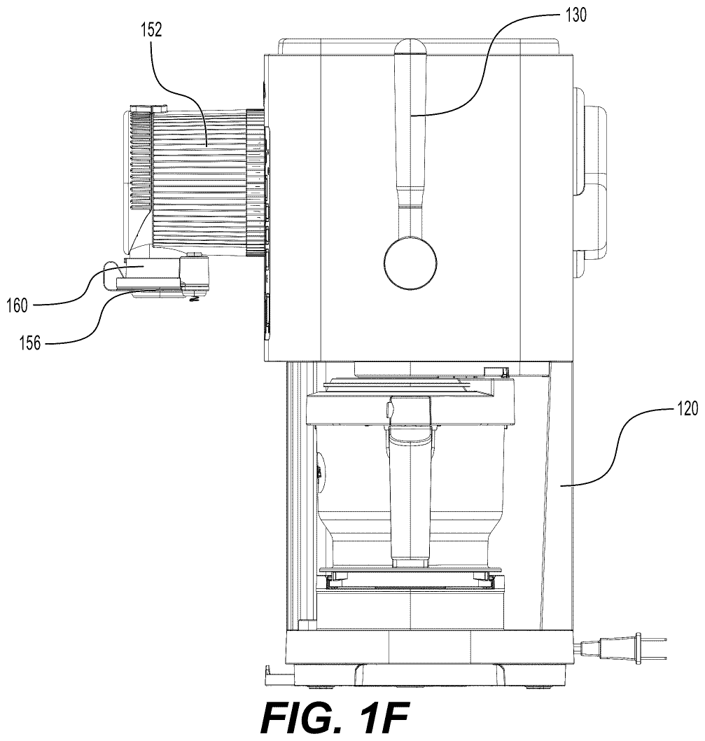

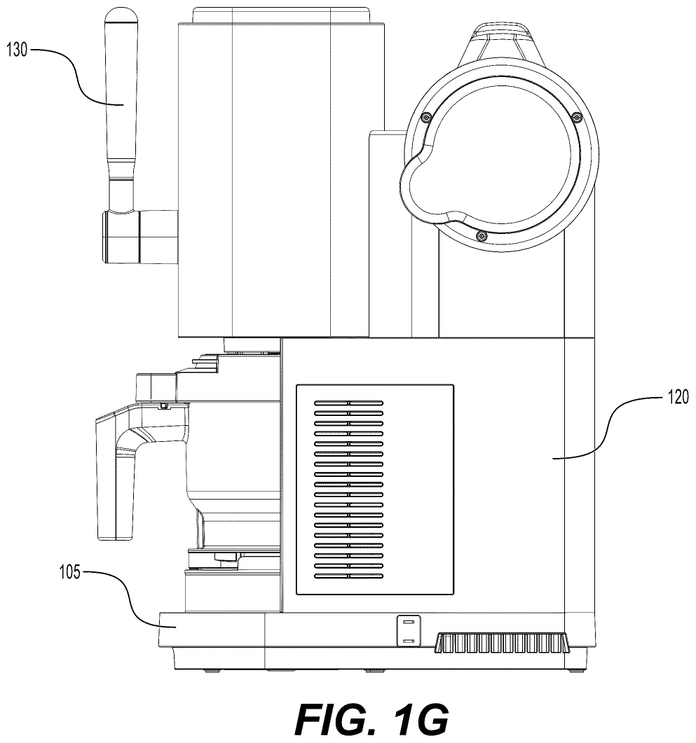

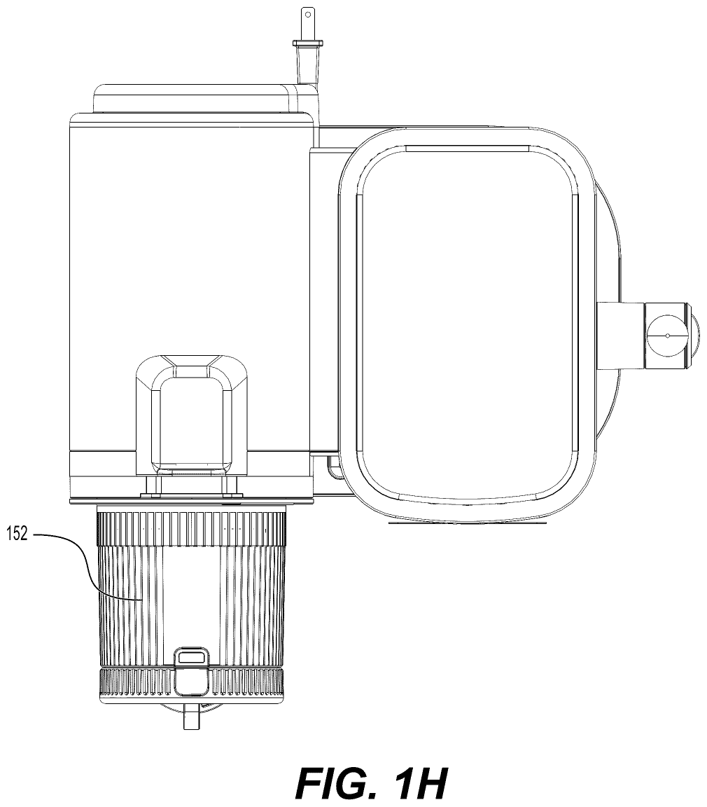

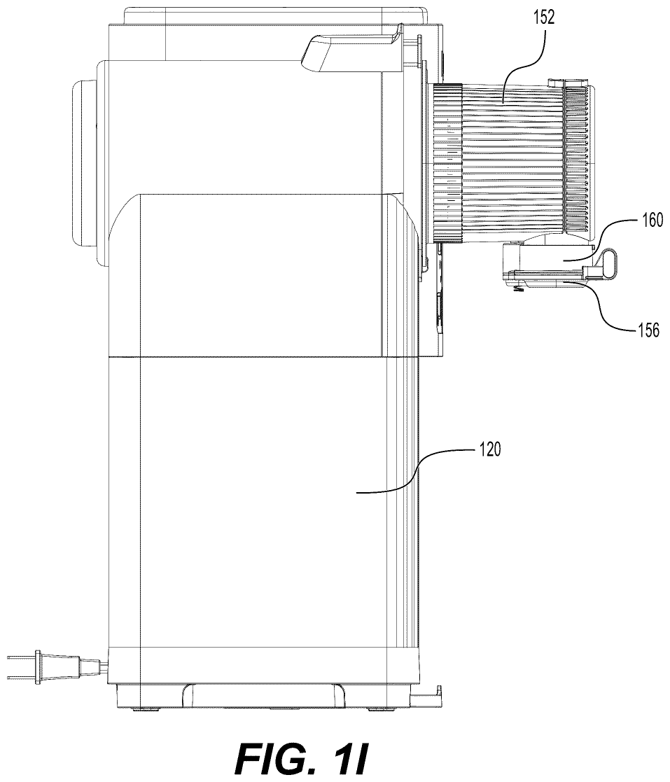

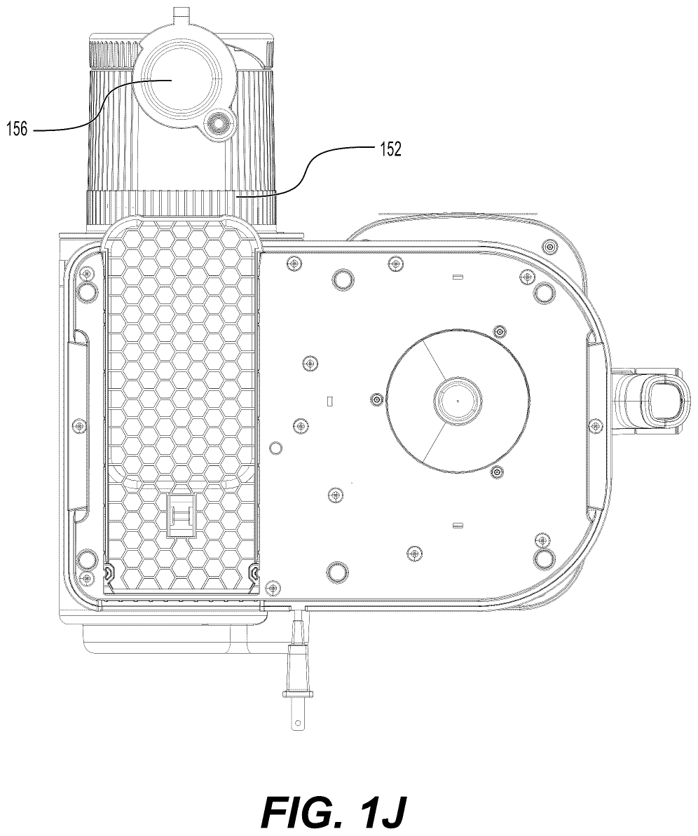

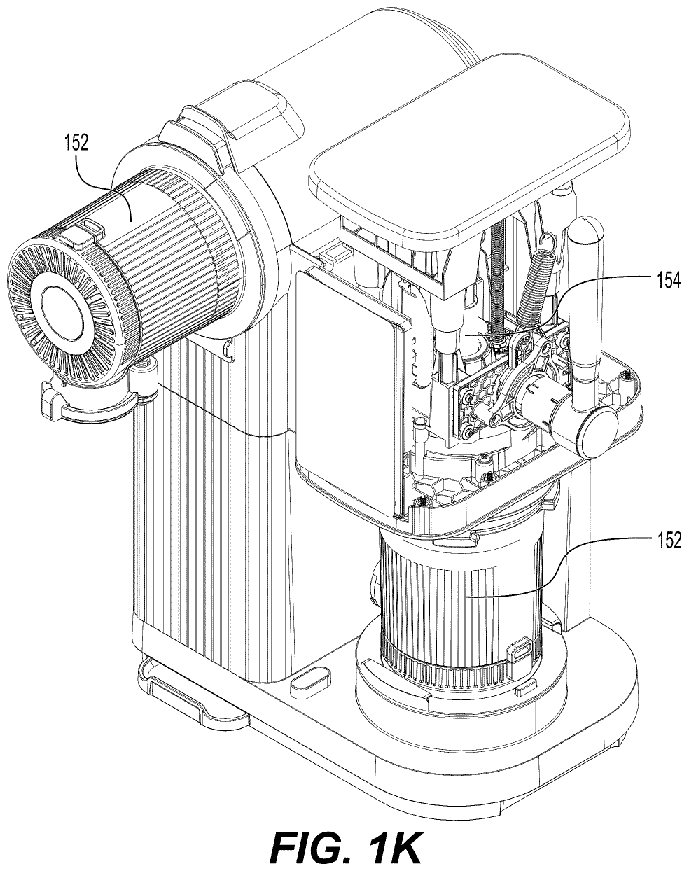

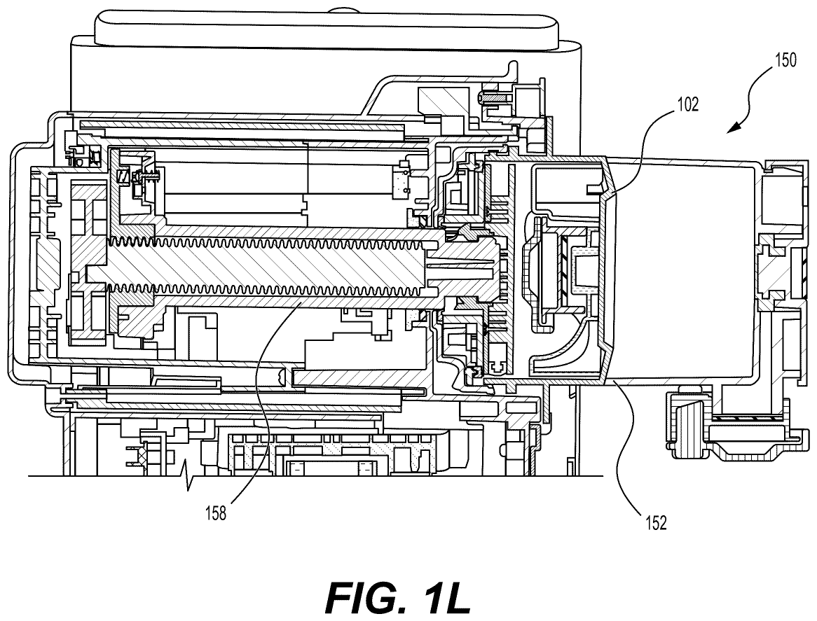

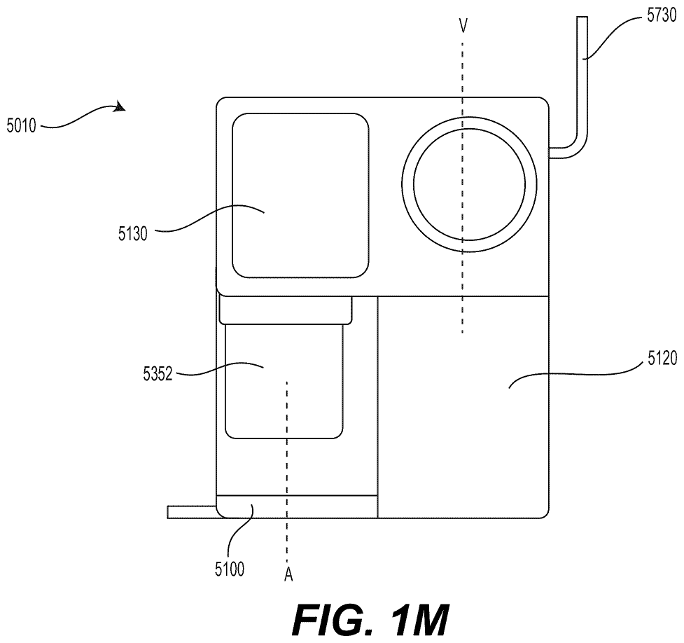

FIGS. 1A-1M are schematic diagrams of a micro-puree machine 100, according to an embodiment of the invention. FIGS. 1A and 1B illustrate an embodiment of micro-puree machine 100 in a first configuration for processing (e.g., micro-pureeing), which may be referred to herein as a processing configuration. FIGS. 1C and 1D illustrate an embodiment of micro-puree machine 100 in a first configuration for extruding, which may be referred to herein as an extruding or extrusion configuration. FIGS. 1E-1L illustrate an embodiment of micro-puree machine 100 in both processing and extruding configurations merely for illustrative purposes, as in some embodiments, the micro-puree is not configured to perform processing and extruding concurrently.

The micro-puree machine 100 may include a base 105 and a housing 120. The housing 120 may include a user interface 110 for receiving user inputs to control the micro-puree machine 100 and/or display information. In some embodiments, the micro-puree machine includes a processing sub-module 121 including one or more components configured to process ingredients in a processing bowl 152 and an extruding sub-module 123 including one or more components configured to extrude processed ingredients from the processing bowl 152. Micro-puree machine 100 also includes an extrusion interface 129 whereby the processing bowl 152 can be coupled to the micro-puree machine 100 to facilitate extrusion of processed ingredients. Mixing interface 170 and extrusion interface 129 may include, without limitation, bayonet couplers, threaded couplers, snap-on couplers, and the like, that enable processing bowl 152 to detachably connect and/or couple the respective interface for mixing or extruding processed ingredients. In implementations where the mixing interface 170 and extrusion interface 129 include bayonet couplers, the couplers may include one or more female receptors and/or receivers on the micro-puree machine housing that engage with one or more male bayonet protrusions or bayonet tabs of a coupler of the processing bowl 152 when the processing bowl 152 is coupled to the mixing interface 170 or extrusion interface 172.

In a processing configuration, the processing bowl 152 may be coupled to the interior of an outer bowl 107 that is mounted on a processing platform 109 mounted to the base 105. The processing bowl 152 may be coupled to a lid 111 that houses a blade assembly 113. The processing bowl 152 may include a nozzle control assembly 151 (e.g., a dial) that enables a user to control an opening or closing of a nozzle 160 and a drip stop 156 that can be used by a user to selectively cover the nozzle 160, or the control assembly 151. In some implementations, the nozzle control assembly 151, the nozzle 160, and the drip stop 156 may be removably attachable to the processing bowl 152. Using the handle 125, a user may rotate and elevate the processing bowl assembly 117 into a processing position in which the blade assembly 113 engages with a driven shaft 154, the lid 111 couples to the micro-puree machine, and a blade is released from the lid 111 so the driven shaft 154 can drive the shaft 154, for example, as described in the as described in U.S. Pat. No. 11,871,765 to SharkNinja Operating, LLC, the entire contents of which are hereby incorporated by reference (the '756 patent). By engaging the user interface (or via a remote interface wirelessly connected to a wireless interface within housing 120), the user may initiate processing of the ingredients in the processing bowl 152. In a processing configuration, extruding sub-module 123 may remain idle, and a cap or plug 119 may be coupled to a coupling 127, covering an interface 129 with driven shaft 158.

After the processing of the ingredients, the processing bowl assembly 117 may be decoupled from the micro-puree machine 110 (e.g., from the processing sub-module 121), and de-mounted from the platform 109. The lid 111 may be removed from the outer bowl 107, and processing bowl 152 removed from the outer bowl 107. A lid 153 then may be mounted to the processing bowl 152, and the processing bowl 152 then may be coupled to the micro-processing machine 110 (e.g., to the extruding sub-module 123) in an extruding configuration.

In the extruding configuration, the processing bowl 152 may be coupled to a lid 153 that includes a plunger. The combination of the processing bowl 152 and the lid 153 may be referred to herein as a bowl extruding assembly 150. In embodiments, the bowl extruding assembly 150 may be configured to be installed to the micro-puree machine 100 such that the nozzle 160 faces vertically downwards when the bowl extruding assembly 150 is properly installed. The bowl extruding assembly 150 may be assembled to the housing 120 (e.g., the extruding sub-module 123) such that a central axis A of the bowl extruding assembly 150 extends perpendicular to a vertical axis V of the housing 120, as shown. The bowl extruding assembly 150 may include an outlet 160 for extruding processed ingredients from the bowl extruding assembly 150. The micro-puree machine 100 also may include a lever 130 for manually activating a plunger 102 to extrude processed ingredients within the bowl extruding assembly 150 through the outlet 160.

While the lever 130 is illustrated on a right side of the machine 100 (from the front view shown in FIG. 1B), the disclosure is not so limited. The lever 130 may be on the left side of, or another location on, the machine 100, and other components of the machine may be rearranged to accommodate the different location of the lever 130. The housing 120 may include electrical, electromagnetic, mechanical and/or electro-mechanical components to translate a pulling down or pushing up of the lever 130 into movement of a plunger (e.g. plunger 102) within the processing bowl 152.

Implementations of the housing 120 of micro-puree machine 100 may house a transmission system that includes a driven shaft 154 for engaging the blade 113, a separate driven shaft 158 for engaging the plunger 102, on or more gearing systems, and one or more position and/or drive motors for moving the driven shaft 154 and the other shaft 158 rotationally and/or axially to process the ingredients in the bowl assembly 150. For example, a drive motor may drive the rotation of the driven shaft 154 and blade coupled thereto, and a position motor may drive the vertical (e.g., down and up) movement of the driven shaft and a blade. Another motor may drive the second shaft 158 and a plunger attached thereto. In embodiments, the blade 113 may be programmably controlled at the user interface 110 by a computing system to operate at different rotational speeds and moved up and down in different patterns and speeds, and for different periods of time, to make different food items. In embodiments, the plunger in the lid 153 may be programmably controlled at the user interface 110 by a computing system to operate at different rotational speeds and moved up and down in different patterns and speeds, and for different periods of time, to make different food items. Some non-limiting examples of a transmission system and the computing system are shown in described in the '765 patent and in U.S. Pat. No. 11,882,965 to SharkNinja Operating, LLC (the '965 patent), the entire contents of which are hereby incorporated by reference.

FIG. 1M shows an isometric view of a micro-puree machine 5010, according to another embodiment of the disclosure. The micro-puree machine 5010 may be used to process ingredients on one shaft and extrude the processed ingredients on another shaft. As shown in FIG. 1M, the micro-puree machine 5010 may include a base 5100, a housing 5120, and an extrusion module 5130. The housing 5120 may include a user interface (not shown) for receiving user inputs to control the micro-puree machine 5010 and/or display information. The micro-puree machine 5010 also may include a bowl 5352. The bowl 5352 may be assembled to the housing 5120 such that a central axis A of the bowl 5352 extends parallel to a vertical axis V of the housing 5120, as shown. However, the disclosure contemplates that the bowl 5352 may be assembled to the housing 5120 such that the central axis A extends at an angle of between 0 and 90° to the vertical axis V, or such that the central axis A extends perpendicular to the vertical axis V.

The extrusion module 5130 may be configured to couple to a bowl assembly as described herein, for example, a bowl having a lid with e a plunger housed therein. The extrusion module 5130 also may include a motor and transmission to drive a driven shaft to move the plunger with the bowl during extrusion, for example, as described elsewhere herein. The micro-puree machine 5010 also may include a lever 5730 for activating the plunger to extrude processed ingredients from the bowl 5352 through an integrated nozzle in the bowl 5352 (not shown). The housing 5120 may include electrical, electromagnetic and/or mechanical components the translate a pulling down or pushing up of the lever into movement of the plunger within the bowl.

The nozzle may be integrated with the bottom surface of the bowl 5352 such that nozzle faces vertically downwards when the bowl 5352 is properly installed. In the embodiment of FIG. 1J, the plunger may be configured to extrude the processed ingredients from the bowl 5352 using a separate shaft (not shown) from a driven shaft (e.g., 250) that rotates a blade (e.g., 300). In further embodiments, the separate shaft may be manually driven by the user by cranking the lever 5730.

In some embodiments of the disclosure, a drip stop for an extrusion nozzle of a micro-processing machine (or other type of device for processing food) may be provided, as now will be described.

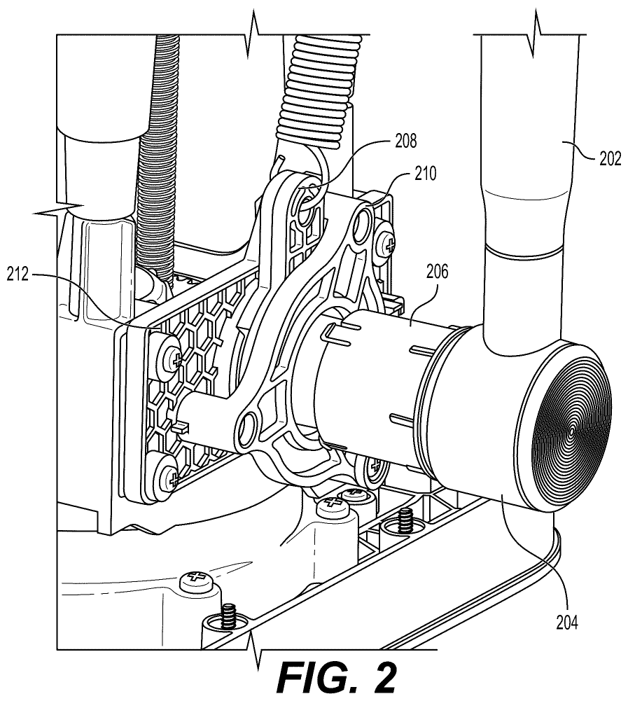

FIG. 2 is a detailed schematic diagram of a handle 200 used with micro-puree machine 100, according to an embodiment of the invention. For discussing the features of handle 200, housing 121 has been removed to show some internal components used in conjunction with handle 200. Handle 200 includes a lever 202, arm 204, and a sleeve 206. Lever 202 vertically extends from the arm 204. Sleeve 206 is positioned on the arm 204 and connected to a rotation structure 208. An interface 210 is positioned on plate 212 and positioned between arm 204 and a rotation structure 208. Rotation structure 208 is configured to increase resistance when a user pulls lever 202 and returns lever 200 to its original position when it releases lever 202. Interface 210 is configured to protect the rotation structure 208 and securely connect rotation structure 208 to arm 204. Plate 212 is configured to provide structural support for interface 210 and protect a variable resistor on the other side of plate 212. Further information regarding the variable resistor will be provided below.

A user utilizes handle 200 to control the speed of the motor of micro-puree machine 100 to extrude food materials in processing bowl 152. In this case, the user may adjust the rotation angle of lever 200 to determine electrical signal amplitudes. These electrical signal amplitudes are converted into a motor input to tie the handle angle to extrusion speed, which will be described further. In this case, if the user pulls less, the motor moves slowly; if the user pulls the handle 200 for the complete length of travel, the motor moves at maximum speed.

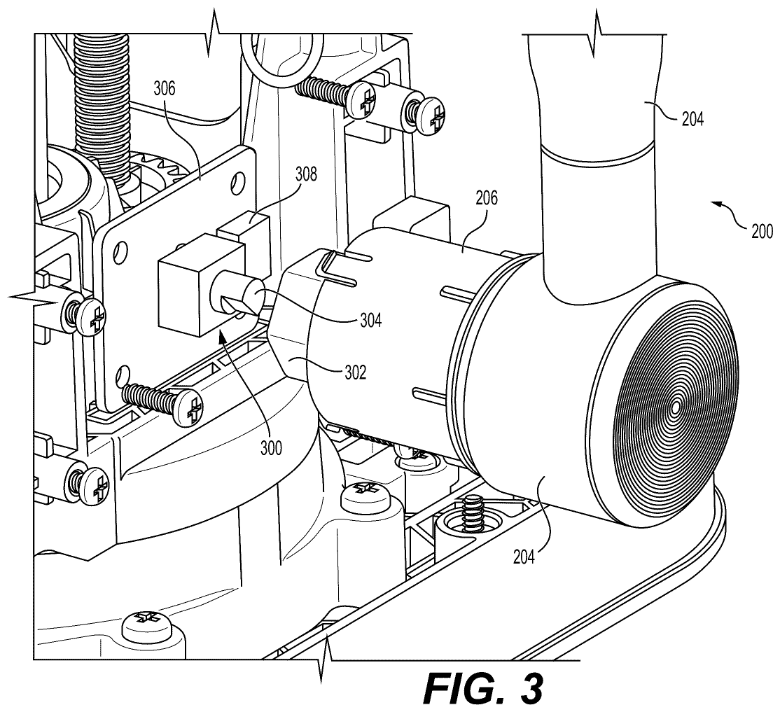

FIG. 3 is a schematic diagram of a variable resistor 300 used with micro-puree machine 100, according to an embodiment of the invention. To show the details of variable resistor 300, plate 212 of FIG. 2 is removed. The arm 204 includes a rotational coupler 302 connecting to a post 304 of variable resistor 300. Rotation of the handle 200 rotates post 304, via rotational coupler 302, on variable resistor 300 to determine input voltage to the DC motor of micro-puree machine 100. Variable resistor 300 adjusts with the rotation of handle 200. The resistance of variable resistor 300 changes as the angle of the lever 202 changes. Variable resistor 300 is positioned on a printed circuit board assembly (PCBA) 306 to provide all the necessary electrical connections for variable resistor 300 to operate. While embodiments of the disclosure describe a variable resistor as being part of a handle operated by a user, the invention is not so limited. It should be appreciated that variable resistor may be coupled to the handle, but disposed separate from the handle inside a housing of the micro-puree machine.

When a user rotates handle 200, this results in post 304 of variable resistor 300 being rotated resulting in a resistance signal being produced by variable resistor 300. Variable resistor 300 sends the resistance signal to an electrical coupler 308. Electrical coupler 308 may send the resistance signal to a circuit, for example, in a main PCBA 400, for signal interpretation. Electrical coupler 308 sends signals indicative of the resistance from variable resistor 300.

In some implementations, an encoder may be used instead of variable resistor 300. The encoder may be positioned on PCBA 306 and is connected to arm 204 of handle 200. The encoder may adjust its output signal as the angle of the lever 202 changes causing rotational changes to arm 204. The encoder may send its output signal to electrical coupler 308 to a circuit, for example, in a main PCBA 400, for signal interpretation.

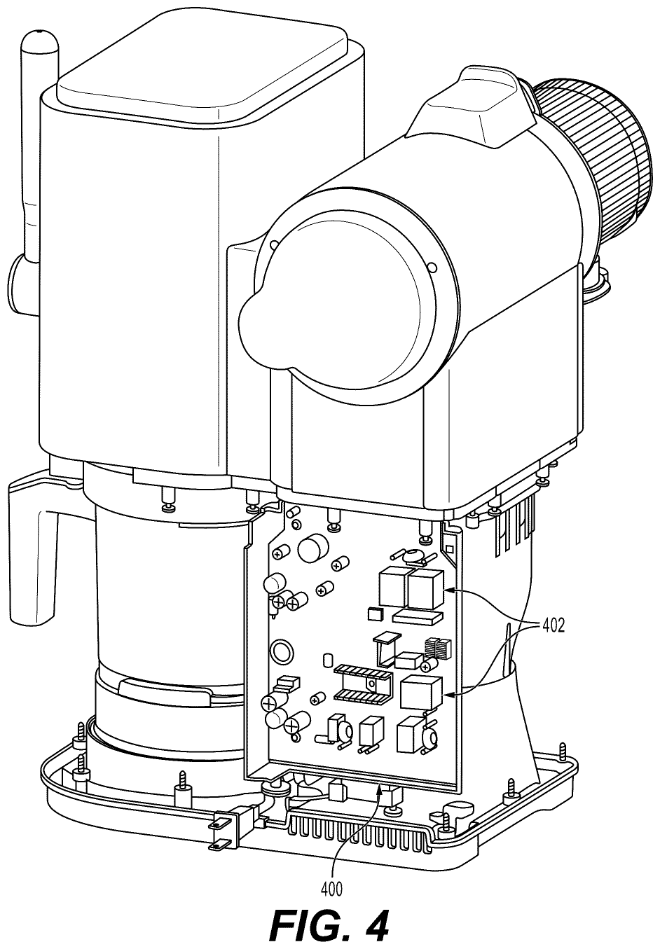

FIG. 4 is a schematic of a main PCBA 400 used by micro-puree machine 100, according to an embodiment of the invention. PCBA 400 is electrically connected to PCBA 306 and configured to receive output signals from variable resistor 300 to control the motor's output for extruding food materials from processing bowl 152. Also, PCBA 400 is positioned on the backside of micro-puree machine 100. In other implementations, PCBA 400 may be positioned in different locations in micro-puree machine 100. Moreover, PCBA 400 includes several electrical components, 402, for processing the output signals of variable resistor 300 and controlling other operational features of micro-puree machine 100, such as temperature control, user interface operations, and the like.

The electrical components 402 may be one or more circuits, such as one or more processors, one or more memories for storing software programs, communication modules for communicating with an external device, such as a computer or smartphone, or the like. In this implementation, electrical components 402 of PCBA 400 may include a processor and memory for executing the software program for interpreting the resistance observed at variable resistor 300 and outputting the interpreted signals to the motor indicative of its output speed. The output speed of the motor is correlated to the extrusion speed of the food materials from processing bowl 152.

PCBA 400 stores and executes a software program that may interpret the resistance from variable resistor 300, from which the output speed of the motor may be determined (e.g., selected from a look-up table based on the resistance value or calculated from the resistance value using a predefined formula). For example, the resistance may be assigned into one or a plurality of predefined bands associated with the angle of lever 202, where each band of the resistances corresponds to variable resistor 300, outputting different signals associated with different output speeds of the motor. The number of bands may depend on the size, power considerations, or other factors of micro-puree machine 100. PCBA 400 sends the interpreted signals to a motor to operate at the designated output speed.

In some implementations, the software program for interpreting the resistance observed at variable resistor 300 may be implemented, solely or at least partially, using hardware. The hardware may be implemented on PCBA 400.

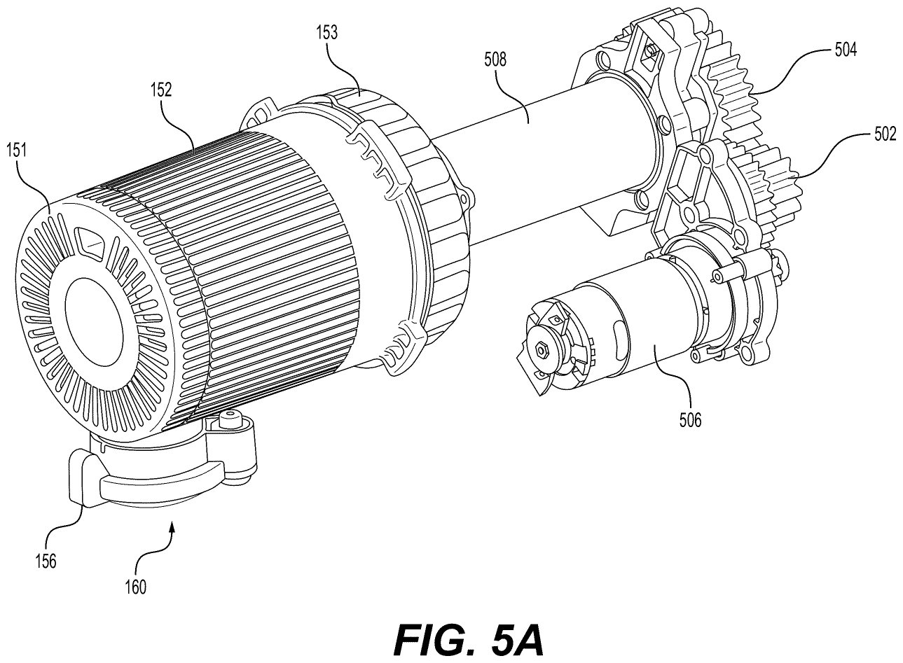

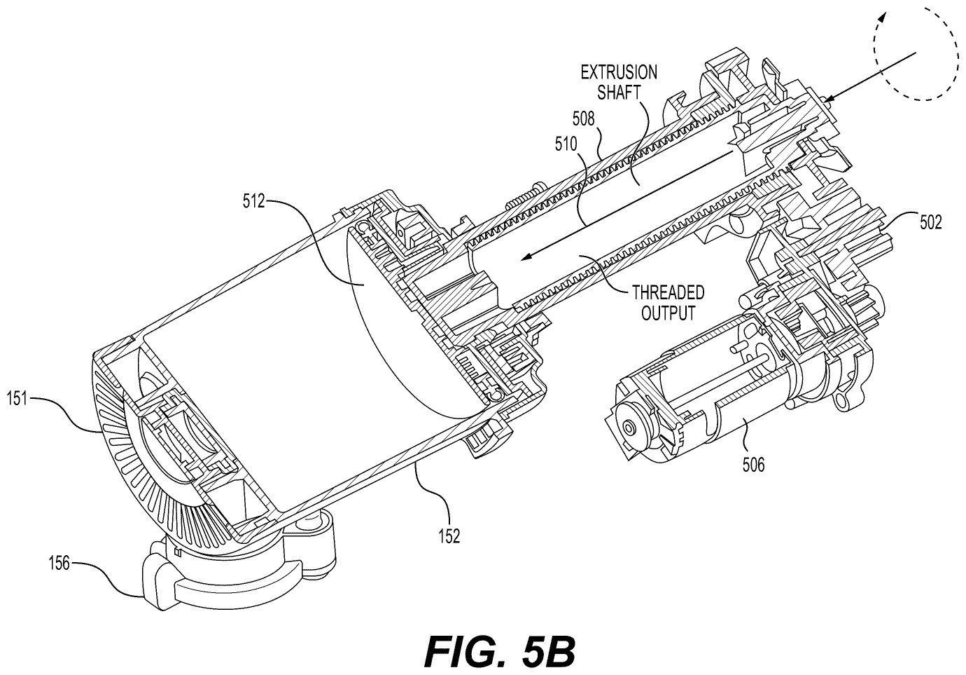

FIGS. 5A-5B are schematic diagrams of components 500 of micro-puree machine 100 involved in the extrusion process, according to an embodiment of the invention. FIG. 5A shows a first gear 502 and second gear 504 forming a multiple-stage planetary and spur gear drivetrain 500 to drive an extrusion output shaft 510 enclosed in a shaft housing 508. In this implementation, the extrusion output shaft 510 may be threaded. First, gear 502 is connected to motor 506. Motor 506 receives electrical signals via an electrical coupler 514 from PCBA 400 to define the output speed of motor 506. Motor 506 may be a DC motor, A/C motor, or the like. In addition, motor 506 rotationally drives a multiple-stage planetary and spur gear drivetrain 500 at the output speed. This results in multiple-stage planetary and spur gear drivetrain 500 producing a rotational output that drives extrusion output shaft 510 at a speed corresponding to the output speed of the motor 506.

Extrusion output shaft 510 is connected to extrusion lid 153. Also, extrusion output shaft 510 is connected to a plunger 512 of extrusion lid 153, as shown in FIG. 5B. In this implementation, processing bowl 152 includes food materials stored within. Extrusion lid 153 is connected to processing bowl 152, allowing plunger 512 access within processing bowl 152 to extrude the food materials. In this implementation, extrusion output shaft 510 is a threaded output shaft that converts the rotational motion of multiple-stage planetary and spur gear drivetrain 500 into axial translation used by plunger 512 to extrude the food materials to extrusion nozzle 160 when drip stop 156 is in the open positioned.

Thus, the angle at which the lever 202 is turned relative to the arm 206 may generate a resistance from variable resistor 30X, which in turn generates a speed of the motor 506, which in turn produces a speed of descent of the driven shaft 510 and plunger 512 with the processing bowl 152, which results in food materials (e.g., processed frozen or semi-frozen ingredients) extruding at a rate corresponding to the rate of descent of the plunger 512. That is, ultimately the contents of the processing bowl are extruded at a rate corresponding to the angle at which the lever 202 is turned relative to the arm 206.

In some implementations, similar mechanical rotational devices may be used in place of multiple-stage planetary and spur gear drivetrain 500 to work with extrusion output shaft 510. In some implementations, extrusion output shaft 510 may not be threaded to generate axial translation used by plunger 512.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A handle for a micro-puree machine comprising:
a lever;
an arm coupled to the lever, the arm configured to allow the lever to rotate about the arm at an angle; and
an electrical circuit coupled to the arm, the electrical circuit configured to produce an electrical signal based on the angle rotated by the lever.

2. The handle of claim 1, wherein the lever is vertically positioned on the arm.

3. The handle of claim 1, wherein the arm is coupled to a rotation structure configured to increase resistance when a user pulls the lever.

4. The handle of claim 3, further comprising an interface positioned between the arm and the rotation structure, wherein the interface is configured to protect the rotation structure.

5. The handle of claim 1, wherein the plate is configured to protect the electrical circuit.

7. The handle of claim 1, wherein the electrical circuit is a variable resistor or a encoder.

8. The handle of claim 1, wherein the electrical circuit is coupled to an electrical coupler configured to send outputs from the electrical circuit to one or more electrical components.

9. A micro-puree machine comprising:
a motor;
extrusion output shaft coupled to the motor, the extrusion output shaft extruding food materials in a processing bowl of the micro-puree machine based on an output speed of the motor;
a handle coupled to the motor, the handle including:
a lever; and
an arm coupled to the lever, the arm configured to allow the lever to rotate about the arm at an angle;
a first electrical circuit coupled to the arm, the first electrical circuit configured to produce a first electrical signal based on the angle rotated by the lever; and
a second electrical circuit coupled to the motor, the second electrical circuit configured to receive the electrical signal corresponding to the angle rotated by the lever from the first electrical circuit and generate a second electrical signal indicative of the output speed of the motor, wherein the motor receives the second electrical signal from the second electrical circuit and generates the output speed.

10. The micro-puree machine of claim 9, wherein the lever is vertically positioned on the arm.

11. The micro-puree machine of claim 9, wherein the arm is coupled to a rotation structure configured to increase resistance when a user pulls the lever.

12. The micro-puree machine of claim 11, further comprising an interface positioned between the arm and the rotation structure, wherein the interface is configured to protect the rotation structure.

13. The micro-puree machine of claim 12, wherein the interface is positioned on a plate for support.

14. The micro-puree machine of claim 9, wherein first electrical circuit is a variable or an encoder.

15. The micro-puree machine of claim 9, wherein the first electrical circuit is coupled to an electrical coupler configured to send outputs from the first electrical components to one or more electrical components.

16. The micro-puree machine of claim 9, wherein the extrusion output shaft is coupled to a drivetrain.

17. The micro-puree machine of claim 16, wherein the drivetrain comprises a plurality of gears for producing rotational motion.

18. The micro-puree machine of claim 9, wherein the second electric circuit is positioned on a printed circuit board assembly (PCBA).

19. A method of extruding food in a micro-puree machine including a user-operated lever, the method comprising:
generating, using a first electrical circuit coupled to the lever, a first electrical signal based on an angle of rotation of the lever by a user;
sending the first electrical signal indicative of the angle of rotation of the lever from the first electrical circuit to a second electrical circuit;
generating, using the second electrical circuit, a speed signal from the first electrical signal, the speed signal indicative of the output speed of a motor of the micro-puree machine;
sending the speed signal to the motor to generate the output speed; and
extruding food materials in a processing bowl of the micro-puree machine based on the output speed of the motor.

20. The method of claim 19, wherein extruding food materials includes controlling a rate of movement of a plunger along a major axis of a bowl including the food materials based on the speed of the motor.
